(19) United States
(12) Patent Application Publication
(10) Pub. No.: US 2023/0003224 A1
(43) Pub. Date: Jan. 5, 2023

(54) MECHANICAL ASSEMBLY FOR A VEHICLE AND VENTILATOR DEVICE FOR A VEHICLE COMPRISING SUCH A MECHANICAL ASSEMBLY

(71) Applicant: Valeo Systemes Thermiques, Le Mesnil Saint-Denis (FR)

(72) Inventors: Clara Degorce-Dumas, Le Mesnil Saint Denis (FR); Clémence Kwaczewski, Le Mesnil Saint Denis (FR)

(73) Assignee: Valeo Systemes Thermiques, Le Mesnil Saint-Denis (FR)

(21) Appl. No.: 17/771,937

(22) PCT Filed: Oct. 13, 2020
(86) PCT No.: PCT/FR2020/051801

§ 371 Date: Apr. 26, 2022

(30) Foreign Application Priority Data
Oct. 28, 2019 (FR) 1912085

(51) Int. Cl. F04D 25/06; F04D 25/08; F04D 29/66; F16F 15/08; H02K 5/24; H02K 11/33; B60H 1/00

(52) U.S. Cl. CPC F04D 25/06; F04D 25/08; F04D 29/668; F16F 15/08; H02K 5/24; H02K 11/33; B60H 1/00521; F16F 2224/025; F16F 2228/007; F16F 2232/02; H02K 2211/03

(57) ABSTRACT

A mechanical assembly for a vehicle (10), in particular a motor vehicle, comprises a rotating element (18), a support Got (20) for the rotating element (18), and a cover (22) attached on the support (20) for the rotating element (18). The cover (22) has at least one edge (50) attached on the support (20) for the rotating element (18) and a bottom (52) extending substantially in a plane. The N bottom (52) is at least partially covered by elastomer material (58).

### TECHNICAL FIELD

The present description relates to a mechanical assembly for a vehicle, and to a fan device comprising such a mechanical assembly, for a motor vehicle ventilation installation.

### PRIOR ART

Motor vehicles are commonly equipped with a heating, ventilation and/or air-conditioning device able to generate an air flow. Such a device is also able to manage the temperature and distribution within the vehicle interior of the air flow created. Such a heating, ventilation and/or air-conditioning device comprises, inter alia, a fan comprising a fan impeller rotationally driven by an electric motor. The electric motor is notably an electronically switched electric motor controlled by a power supply module.

An electronically switched electric motor, or brushless direct current motor, comprises a rotor and stator assembly, each of these components bearing electromagnetic elements whose interaction generates the movement of the rotor in relation to the stator and, ultimately, the movement of the fan impeller.

The electric motor conventionally comprises an external rotor, an internal stator, fixed to a support for the electric motor. A cover is fixed to the support, to define a housing for receiving an electronic control board for the electric motor. Conventionally, this electronic board comprises various electronic elements which give the cover a bowl shape with at least one flat edge or rim, fixed to the motor support, and a substantially flat bottom. This cover is generally stamped in a thin sheet metal.

However, it has been found that the rotation of the rotor can create mechanical excitation resulting in vibrations of the cover. The cover can thus produce a noise in a range of relatively high frequencies. Thus, when the fan is in operation, this noise can be annoying for the passengers of the vehicle.

An object of the present description is to propose such a mechanical assembly that does not have the aforementioned drawbacks.

More generally, the present description aims to propose a solution to the problem mentioned above, which can be implemented in the context of any mechanical assembly comprising at least one rotating element, a support for the rotating element and a cover fixed to the support for the rotating element.

### SUMMARY OF THE INVENTION

To this end, a mechanical assembly for a vehicle, in particular a motor vehicle, is described, comprising:

a rotating element,

a support for the rotating element, and

a cover fixed to the support for the rotating element, the cover comprising at least one edge fixed to the support for the rotating element and a bottom extending substantially in a plane, the bottom being covered at least in part by elastomeric material.

Thus, advantageously, the elastomeric material makes it possible to attenuate the vibroacoustic emissions from the bottom of the cover, excited by the rotation of the rotating element, via the support.

Preferably, the mechanical assembly comprises one or more of the following characteristics, taken alone or in combination:

the bottom is covered with elastomeric material, on its internal face, oriented toward the support for the rotating element, and/or on its external face, opposite to its internal face;

the elastomeric material forms at least one layer of substantially constant thickness, the thickness of the layer of elastomeric material preferably being greater than or equal to 1 mm and/or less than or equal to 3 mm, more preferably substantially equal to 2.5 mm;

the elastomeric material covering at least part of the bottom of the cover is in one piece;
the elastomeric material is overmolded on the bottom, the bottom preferably having reliefs to improve the fixing of the elastomeric material overmolded on the bottom;
the elastomeric material is SEBS, preferably having a hardness greater than or equal to 25 Shore, preferably 40 Shore, and/or less than or equal to 60 Shore;
the mechanical assembly further comprises an electronic board for controlling the rotating element, the support for the rotating element preferably forming, with the cover, a housing for receiving the electronic board;
the support for the rotating element has at least one projecting relief, in contact with the cover, in particular with the bottom of the cover, the projecting relief preferably passing through the electronic board, where appropriate;
the rotating element is an external rotor of an electric motor, a stator of the electric motor preferably being interposed between the external rotor and a cylindrical relief of the support for the rotating element;
the elastomeric material covering at least part of the bottom of the cover is divided into a plurality of pieces;
the elastomeric material covers substantially the entire bottom of the cover;
the elastomeric material is glued to the bottom, in particular by means of a cyanoacrylate glue;
the support for the rotating element is made of aluminum alloy or plastics material filled with metal particles;
the cover is made of aluminum alloy or plastics material filled with metal particles;
the support comprises a substantially flat part extending in a plane perpendicular to the axis of rotation of the rotating element;
the bottom of the cover is substantially parallel to the support and/or to the electronic control board; and
the cover comprises an opening facing a rotation shaft of the rotating element.

According to another aspect, a fan device is proposed, in particular for a ventilation installation for a vehicle, comprising a mechanical assembly as described above in all its combinations, in which the rotating element is an external rotor of an electric motor, and a fan impeller, driven in rotation by the rotor of the electric motor.

### BRIEF DESCRIPTION OF THE DRAWINGS

Other features, details and advantages of the invention will become apparent upon reading the detailed description below, and upon analyzing the appended drawings, in which:

FIG. 1 schematically represents in perspective a fan device;

FIG. 2 is a schematic perspective view of an example of a motor which can be implemented in the fan device of FIG. 1;

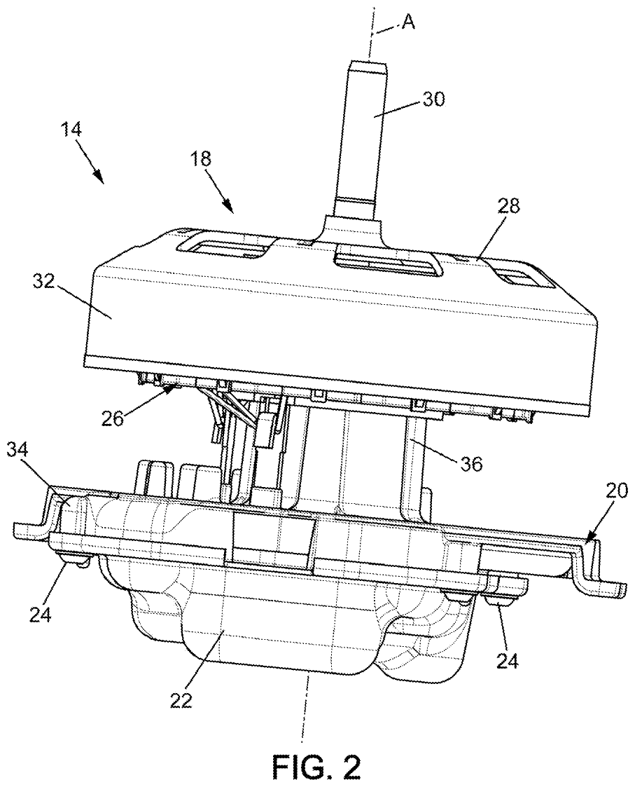

FIG. 3 is a schematic view, from a different perspective, of the example of the motor of FIG. 2;

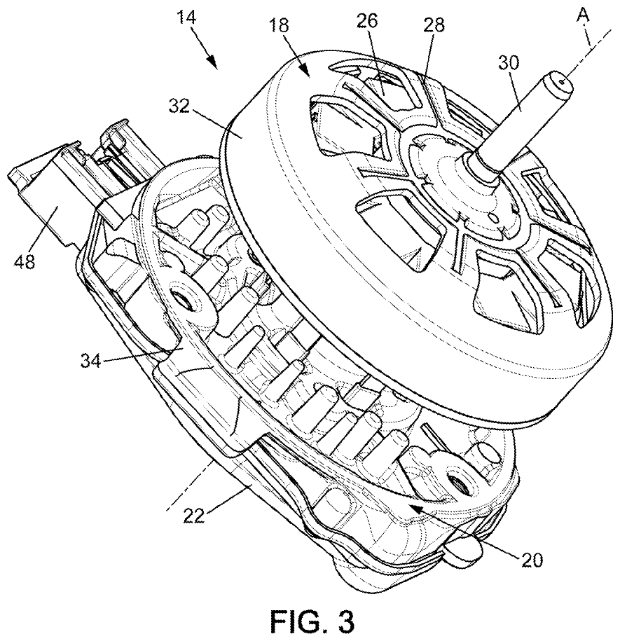

FIG. 4 is a perspective view of a rotor support implemented in the motor of FIGS. 2 and 3;

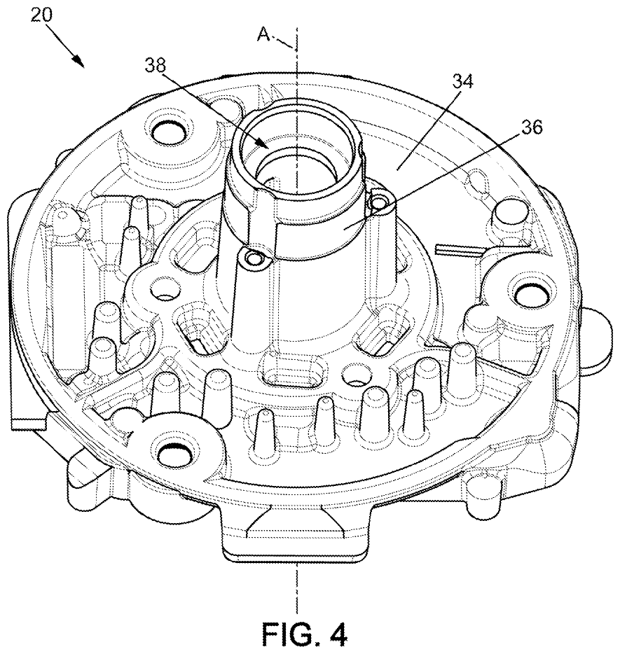

FIG. 5 is a bottom perspective view of the motor of FIGS. 2 and 3, in which the motor cover has been removed;

FIG. 6 is a bottom perspective view of the fan device of FIG. 1;

FIG. 7 schematically illustrates the external face of the motor cover of FIGS. 2 and 3; and

FIG. 8 schematically illustrates the internal face of the motor cover of FIGS. 2 and 3.

### DESCRIPTION OF EMBODIMENTS

In the remainder of the description, elements that are identical or perform identical functions have been designated with the same reference sign. In the present description, for the sake of conciseness, these elements are not described in detail in each embodiment. Rather, only the differences between the variant embodiments are described in detail.

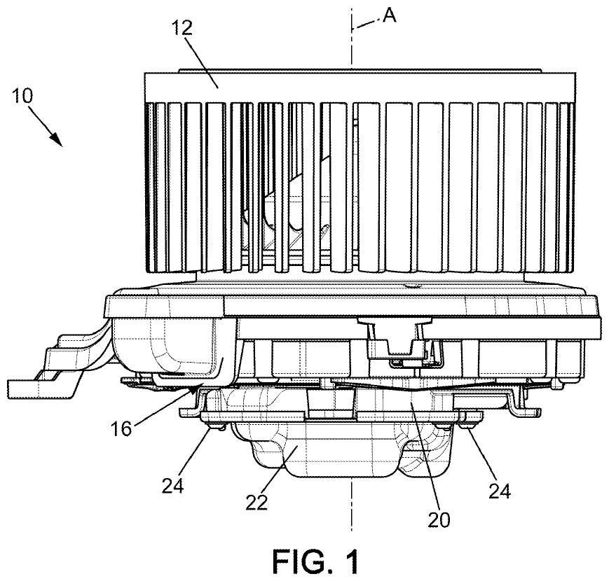

FIG. 1 illustrates a fan device 10 for a vehicle ventilation installation.

The fan device 10 essentially comprises, as shown, a fan impeller 12, an electric motor 14, and a support 16 for the electric motor 14. The fan impeller 12 rotates around an axis of rotation A. The electric motor 14 is intended to rotate, around its axis A, the fan impeller 12. The support 16 for the motor 14 is intended to allow the fixing of the fan device 10 in a motor vehicle, by limiting the transmission of the vibrations generated by the electric motor 14 and/or the fan impeller 12 in the motor vehicle and/or external stresses toward the electric motor 14 and/or the fan impeller 12. The support 16 for the motor 14 may in particular comprise two coaxial rings, of axis A, interconnected by elastomeric material. In particular, the elastomeric material can form a decoupling ring between the inner ring and the outer ring. The inner ring may be intended to be fixed to the motor 14. The outer ring may be intended to be fixed to a structural element, in particular of a vehicle ventilation installation. The elastomeric material is for example polystyrene-b-poly(ethylene-butylene)-b-polystyrene or SEBS.

The electric motor 14 here forms a mechanical assembly comprising a rotating element 18, in this case the rotor 18 of the motor 14, a support 20 for the rotor 18 and a cover 22, fixed to the support 20 for the rotor 18. Here, the cover 22 is fixed on the support 20 for the rotor 18 by means of screws 24. Of course, other fixing means can be implemented to fix the cover 22 on the support 20 for the rotor 18.

The rotor 18 is here an external rotor. Thus, the stator 26 associated with the rotor 18 is arranged radially inside the rotor 18. More precisely, the magnets 27 of the rotor 18 are radially outside with respect to the winding of the stator 26.

The rotor 18 has the shape of a perforated cup 28, fixed to a shaft 30. The fan impeller 12 is here fixed directly on the shaft 30. The magnets 27 of the rotor 18 are here fixed on the internal face of the cup 28, on a cylindrical strip 32 formed by the cup 28.

The support 20 is for example made of an aluminum alloy or a plastics material filled with metal particles.

The support 20 for the rotor 18 here has a base 34. The base 34 here extends wholly in a plane normal to the axis A of rotation of the motor 14. A substantially cylindrical relief 36 extends from the base 34. Here, the relief 36 extends substantially in the direction of the axis A of rotation of the motor 14. The relief 36 is hollow. The relief 36 may in particular form one or two housings 38 each receiving a bearing ring, in particular a ball bearing, intended to guide the rotation of the shaft 30 with respect to the support 20.

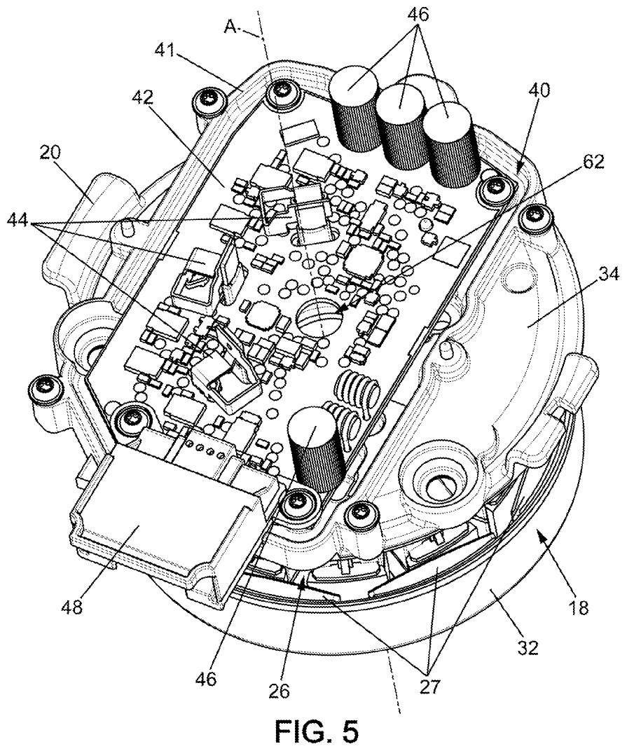

As is more particularly visible in FIG. 5, the base 34 forms on its surface opposite to the cylindrical relief 36 a recess 40 receiving an electronic board 42 for controlling the motor 14. The recess 40 may be surrounded by a projecting rim 41. Various mechatronic components 44, 46 are fixed on the electronic board 42. In particular, mechanical devices 44 make it possible to connect lugs integral with the windings of the stator 26 to the electronic board 42. The power supply of these windings via these lugs can then allow the control of the electric motor 14. The bulkier components 46, in particular the capacitors, can also be fixed on the electronic board 42, preferably near the edges of the electronic board 42.

A connector 48 is also connected to the electronic board 42. The connector 48 allows the electrical supply of the electronic board 42 and, consequently, of the motor 14.

Finally, the cover 22 is fixed on the base 34 of the support 20. The cover 22 defines here, with the recess 40 in the base 34, a housing for receiving the electronic board 42. The cover 22 here comprises an edge 50, which is substantially flat, extending in a plane normal to the axis A of rotation of the motor 14. The edge 50 has holes 51 allowing the fixing of the cover 22 on the base 34 of the support 20, by means of screws 24. The cover 22 also comprises a bottom 52, remote from the edge 50, in the direction of the axis A of rotation of the motor 14. The bottom 52 is here substantially flat. The bottom 52 extends substantially in a plane normal to the axis A of rotation of the motor 14. The bottom 52 of the cover 22 is here substantially parallel to the base 34 of the support 20. Here, the bottom 52 of the cover 22 is also substantially parallel to the electronic board 42.

The bottom 52 is here almost completely covered with elastomeric material. The elastomeric material makes it possible to damp the oscillations of the bottom of the cover. This limits the vibroacoustic emissions from the bottom 52 of the cover 22, excited by the rotation of the rotor 18 of the motor. This makes it possible in particular to reduce the sound emissions of the fan device 10, in a range of audible frequencies, which are felt as unpleasant by the occupants of the vehicle equipped with the fan device 10.

The cover 22 is for example made of aluminum alloy or plastic filled with conductive particles, in particular plastic filled with metal particles.

It should be noted here that the cover 22 shown comprises peripheral bosses 54, 56. These bosses 54, 56 allow the reception of the bulkiest electronic devices 46, in particular those which are tallest in the direction of the axis A of rotation of the motor 14. These bosses 54, 56 are not considered here as forming part of the bottom 52 of the cover 22. Indeed, it is understood that the bottom 52 of the cover 22 is the central part of the cover 22, as opposed to the edge 50, which central part is substantially flat. The bosses 54, 56, on the contrary, due to their curved shape, have a limited tendency to vibrate under the effect of the excitation due to the rotation of the rotor 18.

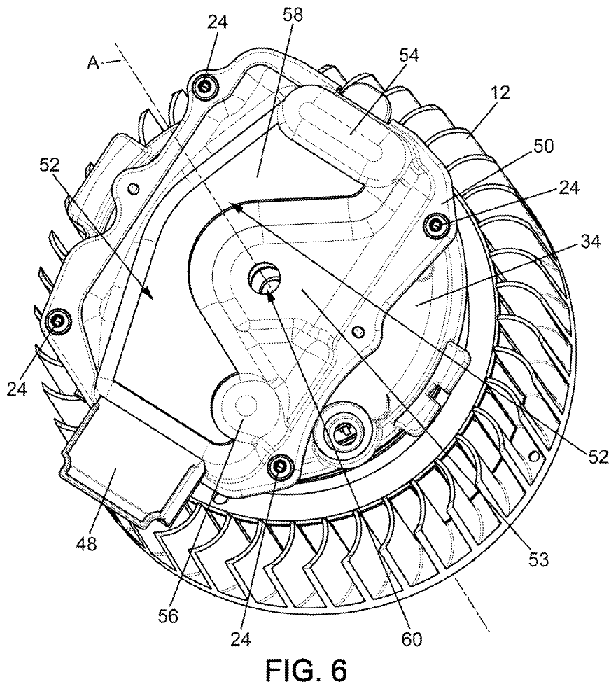

In the example illustrated in FIGS. 6 to 8, in particular, the cover 22 also has a flat surface 53, closer to the edge 50 than the bottom 52, in the direction of the axis A of rotation of the motor 14. This flat surface 53 is also not considered to form part of the bottom 52 of the cover 22. In addition, this flat surface 53, closer to the edge 50, vibrates much less than the bottom 52, so that the vibroacoustic emissions from this flat surface 53 are significantly reduced compared with the vibroacoustic emissions from the bottom 52 of the cover 22.

In practice, the bottom 52 is covered at least in part by elastomeric material. The bottom 52 can in particular be completely covered with elastomeric material, for a better effect of reducing the noise emitted by the cover 22. However, depending on the particular shape of a cover 22, for example, it may be chosen, on the contrary, to limit the surface of the bottom 52 covered by elastomeric material.

The elastomeric material covering at least part of the bottom 52 of the cover 22 can be in one piece or be divided into a plurality of separate pieces. A piece of elastomeric material in one piece is a priori easier to realize A realization in a plurality of separate pieces, however, allows better adaptation to complex reliefs of the cover 22.

The elastomeric material covering the bottom 52 of the cover 22 is for example polystyrene-b-poly(ethylene-butylene)-b-polystyrene or SEBS.

The elastomeric material may in particular have a hardness greater than or equal to 25 Shore, preferably 40 Shore, and/or less than or equal to 60 Shore.

In the example illustrated in FIG. 6, the elastomeric material forms a layer 58, of substantially constant thickness. The thickness of the layer 58 of elastomeric material is for example greater than or equal to 1 mm and/or less than or equal to 3 mm, more preferably substantially equal to 2.5 mm. A greater thickness of elastomeric material makes it possible a priori to obtain a greater reduction in the noise emitted by the cover 22. However, a thinner layer 58 is less expensive and easier to realize.

The elastomeric material, optionally in layer form, can in particular be overmolded on the bottom 52 of the cover 22. In this case, it is particularly advantageous for the bottom 52 of the cover to have reliefs to improve the fixing of the elastomeric material overmolded on the bottom 52. These reliefs can be of reduced dimensions, in particular of the order of a millimeter.

Alternatively, the elastomeric material can be shaped prior to being fixed on the cover 22. In this case, the piece(s) of elastomeric material may in particular be fixed by gluing. A cyanoacrylate glue can in particular be employed in this case.

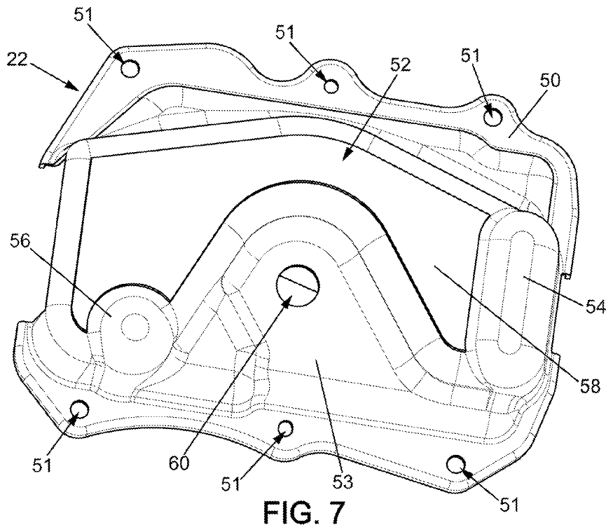

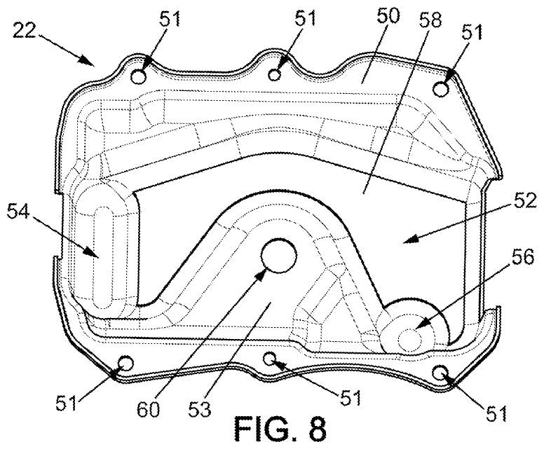

As illustrated in FIGS. 6 and 7, the bottom 52 of the cover 22 may be covered with elastomeric material, on its external face. Alternatively or additionally, as illustrated in FIG. 8, the bottom 52 of the cover is covered with elastomeric material on its internal face, opposite to the external face and oriented toward the support 20 of the rotor 18.

Finally, as can be seen in the figures, the cover 22 and the electronic board 42 can each comprise a through-opening 60, 62 facing the shaft 30 of the rotor 18. These openings 60, 62 can allow the passage of a counter-support for the shaft 30, allowing the fitting of the impeller 12 on the shaft 30. The opening 60 in the cover can then be closed, in particular by means of a sticker. This makes it possible to protect the electronic board 42 against the humidity of the ambient air.

The invention is not limited to the exemplary embodiments described with respect to the figures, and further embodiments will be clearly apparent to a person skilled in the art. In particular, the various examples may be combined, provided they are not contradictory.

According to a variant, in particular, the support has at least one projecting relief, in contact with the cover, in particular with the bottom of the cover. In this case, the projecting relief can advantageously pass through the electronic control board. The projecting relief makes it possible to exert a mechanical stress on the bottom of the cover, which modifies its natural modes of vibration. The action of the elastomeric material is reinforced, and the level of vibrations is again reduced.

Finally, the example of a motor vehicle ventilation device has been described. However, the invention applies to any mechanical assembly for a vehicle, in particular a motor vehicle, comprising a rotating element, a support for the rotating element and a cover fixed to the support for the rotating element. The cover then comprises at least one edge fixed to the support for the rotating element and a bottom extending substantially in a plane, the bottom being covered at least in part by elastomeric material.

1. A mechanical assembly for a motor vehicle, comprising:
a rotating element;
a support for the rotating element; and
a cover fixed to the support of the rotating element, the cover comprising at least one edge fixed to the support of the rotating element and a bottom extending substantially in a plane, the bottom being covered at least in part by elastomeric material.

2. The mechanical assembly as claimed in claim 1, in which the bottom is covered with elastomeric material, on its internal face, oriented toward the support of the rotating element, and/or on its external face, opposite to its internal face.

3. The mechanical assembly as claimed in claim 1, in which the elastomeric material forms at least one layer of substantially constant thickness, the thickness of the layer of elastomeric material being greater than or equal to 1 mm and/or less than or equal to 3 mm.

4. The mechanical assembly as claimed in claim 1, in which the elastomeric material covering at least part of the bottom of the cover is in one piece.

5. The mechanical assembly as claimed in claim 1, in which the elastomeric material is overmolded on the bottom, the bottom having reliefs to improve the fixing of the elastomeric material overmolded on the bottom.

6. The mechanical assembly as claimed in claim 1, in which the elastomeric material is SEBS, having a hardness greater than or equal to 25 Shore, and/or less than or equal to 60 Shore.

7. The mechanical assembly as claimed in claim 1, further comprising an electronic board for controlling the rotating element, the support of the rotating element forming, with the cover, a housing for receiving the electronic board.

8. The mechanical assembly as claimed in claim 1, in which the support of the rotating element has at least one projecting relief, in contact with the bottom of the cover, the projecting relief passing through the electronic board, where appropriate.

9. The mechanical assembly as claimed in claim 1, in which the rotating element is an external rotor of an electric motor, a stator of the electric motor being interposed between the external rotor and a cylindrical relief of the support of the rotating element.

10. A fan device for a ventilation installation for a vehicle, comprising a mechanical assembly as claimed in claim 9; and a fan impeller, driven in rotation by the rotor of the electric motor.
